(19) United States
(12) Patent Application Publication
(10) Pub. No.: US 2006/0267238 A1
(43) Pub. Date: Nov. 30, 2006

(54) Polymer wood composite material and method of making same

(76) Inventor: Walter Wang, Cedar Grove, NJ (US)

Correspondence Address: KENYON & KENYON LLP, ONE BROADWAY, NEW YORK, NY, 10004, US

(21) Appl. No.: 11/142,163

(22) Filed: May 31, 2005

(51) Int. Cl. B29B 7/00

(52) U.S. Cl. 264/122; 264/211; 264/349; 524/27

(57) ABSTRACT

A polymer wood composite material comprises a polymeric component, wood flour, a coupling agent, a thermal stabilizer component, a plasticizer, a foaming agent, and a pigment. Preferably, the composite material exhibits better hardness than natural wood, as well as less water absorption (<5% by weight) and less thickness swelling (<1%) than natural wood when submerged in water for at least 24 hours, wherein the thickness swelling is measured as a percentage of original thickness. The composite material may be used to form a building component for use in the production of furniture and buildings, such as a doorjamb. In addition, a method of producing an extrudable mixture for an extrusion process to produce a polymer wood composite material is disclosed, wherein the method preferably does not include any pre-drying, pre-treatment or pelletizing processes.

### FIELD OF THE INVENTION

The present invention relates to a polymer wood composite material comprising a polymeric component, a foaming agent and wood flour. Preferably, the polymer wood composite material is produced without any pre-treatment or pelletizing, and is extruded to form, for example, a profile building material or a furniture part (such as a door component, a window component, a decking component, and siding for a dwelling).

### BACKGROUND OF THE INVENTION

Woods and metals are common materials used in the manufacturing of buildings and furniture. However, each of these materials has their particular advantageous and disadvantageous properties, and thus several alternatives to these materials have been developed over the years in the fields of construction and manufacturing. For example, there are numerous types of composite materials, which have been developed, to use with and/or in place of woods and metals (such as, for example, polyvinyl chloride (PVC) wood composite, polypropylene (PP) wood composite, and cellular polystyrene (PS)).

For example, U.S. Pat. No. 5,406,768 (“Giuseppe et al.”) discloses an advanced polymer and wood fiber composite structural component. As described in Giuseppe et al., “a substantial need exists for an improved structural member that can be made of a polymer and wood fiber composite.” U.S. Pat. No. 5,406,768, col. 2, lines 19-21. Giuseppe et al. attempt to address this need by providing a composition comprising from 50-70 weight percent of a polyvinyl chloride material, and from 30-50 weight percent of a wood fiber material. See id. at col. 3, lines 37-56. The structural members of Giuseppe et al. are made from this composite material, and they have a hollow cross-sectional shape with a rigid exterior wall, at least one internal structural web and at least one internal fastener web. See id. at col. 2, line 66 to col. 3, line 5. According to Giuseppe et al., “[t]he structural member is typically shaped by the extrusion or injection molding process such that the member can replace a structural or trim component of existing window or door manufacture.” Id. at col. 3, lines 65-68.

U.S. Pat. No. 6,054,207 (“Finley”) discloses a foamed thermoplastic polymer and wood fiber profile and member. Specifically, Finley discloses a member comprising “a thermoplastic foam comprising a foamed composite comprising a thermoplastic polymer and a wood fiber.” U.S. Pat. No. 6,054,207, col. 2, lines 39-41. Finley goes on to disclose that a preferred wood fiber includes the wood by-product or product of sawing or milling of soft woods, a useful thermoplastic polymer includes both condensation polymers and vinyl polymers, and useful blowing agents include “chemical foaming agents such as organic or inorganic bicarbonates or oxylates, azo-chemicals, hydroxides, and amine nitrates.” Id. at col. 8, lines 55-57; see also col. 2, lines 50-54, 62-65. According to Finley, a profile comprising an exterior capping layer over an interior foamed thermoplastic “is structurally strong, thermally stable, shrink resistant and will accept and retain the insertion of fasteners such as staples, nails and screws permanently with substantial retention and little or no damage to the units.” Id. at abstract.

Although composite materials including wood fibers and polymers are known in the art, an ongoing need exists for the production of polymer wood composite materials with improved properties, which can be used in building and manufacturing operations.

### SUMMARY OF THE INVENTION

It is an object of the invention to provide a polymer wood composite material having physical properties which are comparable to or better than those of natural wood, especially in regard to properties of hardness, water absorption and thickness swelling. In addition, such a polymer wood composite material will preferably have a wooden surface appearance and a wooden feel.

It is another object of the invention to provide a method of producing such a polymer wood composite material, including a method of producing an extrudable mixture which is then extruded in order to form the composite material, preferably without any pre-drying or pre-treating of wood flour, or pelletizing.

It is a further object of the invention to provide a building component or a furniture component comprising such a polymer wood composite material, wherein the building component or furniture component can be an interior or exterior material or component, which may be used in indoor or outdoor settings. For example, some such building components and furniture components include door components, window components, decking components, fencing components and the like.

These and other objects of the invention, which will become apparent from the following detailed description, are achieved by providing a polymer wood composite material comprising a polymeric component, wood flour, a coupling agent, a thermal stabilizer component, a plasticizer, a foaming agent and a pigment. Preferably, the polymeric component includes a polyvinyl chloride resin selected from the group consisting of a polyvinyl chloride homopolymer having an inherent viscosity in the range of about 0.65 to 0.94, a polyvinyl chloride copolymer having an inherent viscosity in the range of about 0.65 to 0.94, a polyvinyl chloride terpolymer having an inherent viscosity in the range of about 0.65 to 0.94, and a mixture of polyvinyl chloride polymers having an inherent viscosity in the range of about 0.65 to 0.94. Preferably, the wood flour includes a member selected from the group consisting of hard wood flour having a size in the range of 40 mesh to 140 mesh, soft wood flour having a size in the range of 40 mesh to 140 mesh, and a combination of hard and soft wood flour having a size in the range of 40 mesh to 140 mesh. The coupling agent preferably includes an aminosilane, a mercaptosilane or an alkanolamine, and the thermal stabilizer component preferably includes a liquid mercaptide. Preferably, the plasticizer includes a phthalate, a terephthalate, a benzoate, a trimellitate, a pentaerythritol, an adipate, an azelate, a glutarate or a sebacate, while the pigment preferably includes titanium dioxide in a natural color. Furthermore, the foaming agent preferably includes an exothermic foaming agent, an endothermic foaming agent, or a mixture of exothermic and endothermic foaming agents.

In a preferred embodiment of the polymer wood composite material, the composite material has a hardness which is greater than or equal to natural pine wood as measured on the Rockwell C Hardness scale, and exhibits less than 1% thickness swelling and less than 5% by weight water absorption when submerged in water for at least 24 hours, wherein thickness swelling is measured as a percentage of original thickness.

In accordance with an embodiment of the invention, a method of producing an extrudable mixture for an extrusion process to produce a polymer wood composite material is provided by adding a polymeric component and a coupling agent to a high intensity mixer bowl, mixing the polymeric component and the coupling agent for at least about ten seconds to form a first mixture, adding a thermal stabilizer component to the first mixture to form a second mixture, mixing the second mixture for at least about one minute, adding wood flour to the mixed second mixture to form a third mixture, heating the third mixture to a temperature in the range of about 210 to 220° F., adding a lubricant-stabilizer to the heated third mixture to form a fourth mixture, heating the fourth mixture to a temperature in the range of about 210 to 220° F., adding a plasticizer to the heated fourth mixture to form a fifth mixture, heating the fifth mixture to a temperature in the range of about 215 to 225° F., adding a filler to the heated fifth mixture to form a sixth mixture, heating the sixth mixture to a temperature in the range of about 255 to 265° F., removing the heated sixth mixture from the high intensity mixer bowl, and decreasing its temperature to about 104° F. or less, thereby forming the extrudable mixture.

In a preferred embodiment of the method of the invention, the lubricant-stabilizer comprises at least one process aid, an impact modifier, at least one wax, a lubricant, a pigment and a foaming agent.

### BRIEF DESCRIPTION OF THE DRAWINGS

FIG. 1 shows a schematic representation of various profiles of exemplary embodiments of the building components of the present invention.

FIG. 2 shows a schematic representation of an exemplary embodiment of a breaker plate which may be used in accordance with the present invention.

FIG. 3 shows a schematic representation of a partial cross-sectional view of the exemplary embodiment of the breaker plate of FIG. 2 along line C-D as depicted in FIG. 2.

### DETAILED DESCRIPTION

In accordance with an embodiment of the present invention, a polymer wood composite material includes a polymeric component, wood flour, a coupling agent, a thermal stabilizer component, a plasticizer, a foaming agent and a pigment. In addition, the polymer wood composite material may also include at least one processing aid, an impact modifier, at least one wax, a lubricant and a filler. The composite material is formed by combining these components together in a mixing process to form an extrudable mixture, which is then extruded linearly through a profile die, cooled and shaped by the profile calibrators to form the composite material.

In a preferred embodiment of the invention, the polymer wood composite material is produced without any pre-drying, pre-treatment or pelletizing, such that the composite material can be directly extruded from an extrusion line, having a wooden surface appearance, with a wooden feel and exhibiting physical properties which are comparable to or better than natural wood, such as pine wood. Furthermore, the composite material can be extruded by the Celuka, free foam and/or co-extrusion processes. The composite material can also be extruded to have a particular color, and it can be embossed or capped with stock products.

Once extruded, the composite material of the invention can be cut, fastened, nailed, screwed and glued like wood, yet it exhibits physical properties which are comparable to or better than those of natural wood. For example, a preferred embodiment of the composite material of the invention exhibits better hardness, less water absorption (<5% by weight) and less thickness swelling (<1%) than natural wood. In addition, the composite material exhibits better rot resistant and insect resistant qualities than does natural wood.

The composite material of the invention may be used in many different applications. For example, the composite material can readily be used as a substitute for wood, metal, and the like in the production of furniture and buildings, particularly as door components, window components, decking components, siding and the like. Specifically, the composite material can be used to produce, for example, a doorjamb, a doorsill, a brick mold, a door stile, a door rail, and numerous other parts of buildings and furniture as would be recognized by one of ordinary skill in the art. These building and furniture components of the invention are shaped, formed and produced by conventional processes which are well known in the art.

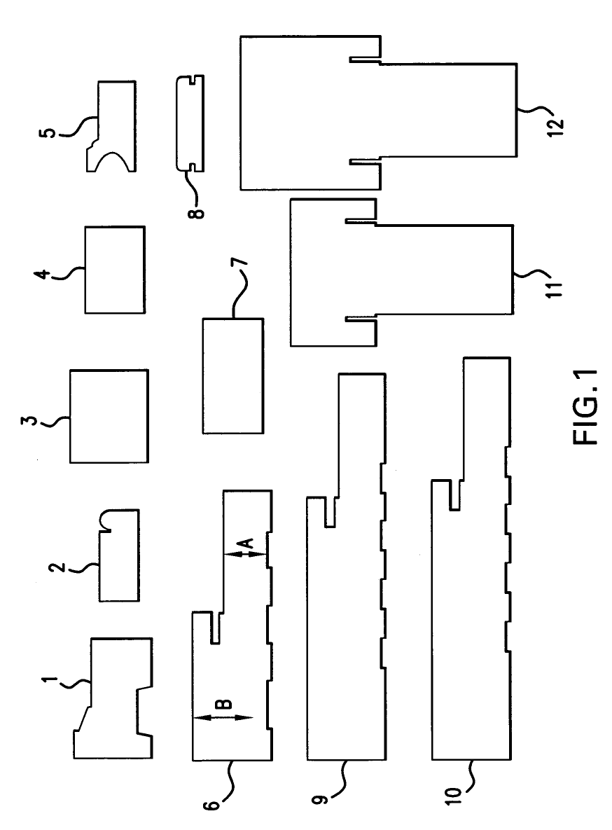

FIG. 1 shows some profiles of exemplary embodiments of the building components of the present invention. Specifically, FIG. 1 shows the profiles of a brick mold 1, a Florida brick mold 2, a door rail 3, a 1.5-inch mull cap 4, a stucco mould 5, a 4 9/16-inch doorjamb 6, a 2-inch mull cap 7, a door stile 8, a 6 9/16-inch doorjamb 9, a 7¼-inch doorjamb 10, a 3 9/16-inch mull post 11, and a 4⅜-inch mull post 12.

Furthermore, the composite material of the invention may also undergo further treatment, depending on its end use. For example, the surface of the composite material may be treated with a primer and then painted to a desired color. In addition, in another embodiment of the composite material, the composite material may itself have a glossy surface and not require any further treatment or painting.

A wide variety of polymers or polymeric resins may be used as the polymeric component of the composite material in accordance with the invention. In a preferred embodiment of the composite material of the invention, the polymeric component comprises polyvinyl chloride (PVC). There are many grades and types of commercially available PVC resins which may be used in accordance with the present invention, such as for example, homopolymers, copolymers and terpolymers. Preferably, the composite material of the invention includes rigid polyvinyl chloride (RPVC) with an inherent viscosity (IV) in the range of about 0.65 to 0.94 (a K value in the range of about 56 to 67), and most preferably with an IV in the range of about 0.65 to 0.80 (a K value in the range of about 56 to 61). Preferably, the polymeric component is present in the polymer wood composite material in an amount in the range of about 44 to 85 weight percent of the composite material, and more preferably, about 51 to 70 weight percent.

As used herein, the term “wood flour” refers to a finely pulverized dried wood, wood shaving, industrial wood sawdust, fines or wood chips as well as other types of natural fibers, which is commonly used as a wood composite material filler in thermoplastic extrusion materials. Wood flour contains pure wood particles without any pre-drying and pre-treatment processing. Any type of wood may be used to produce the wood flour, including hard woods and soft woods, and wood flour can also be produced from paper products. Preferably, the size of the wood fibers which make up the wood flour is in the range of 40 mesh to 140 mesh, and most preferably the wood flour is 80 mesh Maple hard wood flour, which results in an economical composite material with a purer and more even color distribution substantially lacking any dirt or black spots, with a reduced moisture content. In addition, the wood flour is preferably present in the polymer wood composite material in an amount in the range of about 10 to 24 weight percent of the composite material, and most preferably about 16 to 20 weight percent. In comparison to the polymeric resin, the wood flour is preferably present in the polymer wood composite material in an amount in the range of about 15 to 44 phr (corresponding to 10 to 24 weight percent of the composite material), and most preferably about 26 to 35 phr (corresponding to 16 to 20 weight percent of the composite material).

In the composite material, the addition of a coupling agent helps to bind together the polymeric component and the wood fibers of the wood flour. Due to the natural incompatibility of the phases of the typically hydrophilic wood fibers with the typically hydrophobic polymeric matrix, a weak interface results between the wood fibers and the polymeric matrix. Furthermore, strong fiber-fiber interactions between wood fibers resulting from hydrogen bonding can also result from a poor dispersion of the wood fibers in the polymeric matrix. Consequently, the surface modification of the wood fibers and/or the polymeric component is commonly accomplished via addition of a coupling agent, which serves to bring together two otherwise incompatible materials through a chemical bond, specifically by binding them together via an oxygen bond after heating. As would be understood by one of ordinary skill in the art, the coupling agent may include two kinds of reactions, such as for example, the hydrous deposit of silanes and the anhydrous deposit of silanes. That is, a coupling agent may react with water, while it may also react without water; however, both of such reactions will serve to bond to the substrate having a hydroxide group, such as wood fibers. After heating, the hydrogen bond will switch to become an oxygen bond as the hydrogen bond is relatively weak, and the remainder (R) group is the organic group (which is compatible with PVC (organic)).

The addition of the coupling agent results in improved adhesion properties, increased tensile strength, increased impact strength, elongation, increased compressive strength, increased flexural strength, and increased modulus of rupture of the composite material. Examples of the coupling agent include, but are not limited to, aminosilanes, mercaptosilanes and alkanolamine. Preferably, the coupling agent is an aminosilane present in the composite material in an amount in the range of about 0.0 to 4.0 phr, and more preferably in the range of about 0.5 to 3.0 phr.

The composite material of the present invention also includes a foaming agent. Any type of foaming agent may be used in accordance with the present invention. Nearly all foaming agents are chemical foaming agents, of which there are two general types. One type is exothermic foaming agents, which generate heat while producing blowing gases. Exothermic foaming agents normally generate N₂ and have a larger cell structure, a higher gas yield (typically 200 to 240 cm³/g) and a higher decomposition temperature (typically 195 to 300° C.). An exemplary exothermic foaming agent is an azodicarbonamide. Another type of foaming agent is endothermic foaming agents, which absorb heat when reacting. Endothermic foaming agents normally generate CO₂ and have a smaller cell structure, a lower gas yield (typically 110 to 160 cm³/g) and a lower decomposition temperature (typically 100 to 210° C.). Exemplary foaming agents include exothermic foaming agents, endothermic foaming agents and mixed foaming agents (a mixture of exothermic and endothermic foaming agents). A preferred foaming agent is a mixed foaming agent, which may generate nitrogen gas, carbon monoxide, carbon dioxide and water. The addition of the foaming agent serves to achieve cellular expansion of the polymeric component via bubble cells, which inhibit crack propagation by blunting the crack tip and increasing the amount of energy required to spread the crack. Furthermore, the presence of these bubble cells can also reduce the specific gravity of the polymeric component. Preferably, the foaming agent is present in the composite material in an amount in the range of about 0.5 to 3.0 phr, and more preferably about 0.80 to 2.50 phr.

A plasticizer is also included in the composite material of the invention. As is known in the art, a plasticizer is a polymer additive that serves to increase the polymeric component's flexibility, elongation and workability by lowering the glass transition temperature. In general, a plasticizer causes a reduction in the cohesive intermolecular forces along the polymer chains. For example, a plasticizer is not chemically bonding with polyvinyl chloride, but they are both being held together by strong electromotive force as a solid solution. Due to the incorporation of cellulose fibers in polymers, such as polyvinyl chloride, the increased stiffness and melt viscosity of the resulting composite materials have limited the potential for producing a foamed composite material with a high void fraction. Consequently, the addition of a plasticizer plays an important role in the heat processing of the composite material by reducing the melt viscosity, increasing the flexibility and extensibility of the polymeric component, and therefore reducing its stiffness. As a result, during the production of the composite material the rate of cell growth during the foaming would be increased and a higher void fraction would be produced (i.e., more bubble cells and more cellular expansion). Examples of the plasticizer include, but are not limited to: phthalates, terephthalates, benzoates, trimellitates, pentaerythritols, adipates, azelates, glutarates and sebacates. A preferred plasticizer is diisononyl phthalate (DINP), and preferably the plasticizer is present in the composite material in an amount in the range of about 0.0 to 5.0 phr, and more preferably about 1.0 to 4.0 phr.

The composite material of the present invention also includes a pigment. Wood fiber composite materials can have poor heat conductivity, thus causing uneven color distribution when extruded. Therefore, a pigment can be added to the composite material to produce a desired color. In accordance with the present invention, a particularly preferred pigment is a natural-colored (i.e., buff or tan) TiO₂ pigment, such as HITOX®. The addition of HITOX® also provides efficiency in scattering visible light, imparting an even, buff (tan) color, brightness, and high opacity when added into the composite material. Moreover, the ability of the TiO₂ to absorb ultraviolet light energy can provide for significant improvement in the weatherability and durability of the composite material (e.g., by reducing the bleaching of the composite material by the sunlight). By including an inorganic coating on the composite material, the reactive sites on the TiO₂ can be masked, resulting in improved dispersion and weatherability, which leads to a better appearance and more even color. Preferably, the pigment is present in the composite material in an amount in the range of about 0.0 to 4.0 phr, and more preferably about 0.5 to 3.0 phr.

A thermal stabilizer component is also added to the composite material of the invention. The thermal stabilizer component serves to prevent degradation of the polymeric component (such as PVC) during any melting process, as well as to prevent discoloration. The complementary action of a thermal stabilizer component is as an antioxidant. A preferred thermal stabilizer component is a tin stabilizer, such as a liquid mercaptide used in the stabilization of rigid and flexible polyvinyl chloride formulations, including plastisols. Preferably, the thermal stabilizer component is present in the composite material in an amount in the range of about 0.4 to 4.0 phr, and more preferably about 0.5 to 3.0 phr.

In general, the composite materials of this invention are prepared utilizing techniques which are known to those of ordinary skill in the art. As such, the composite materials of this invention may include various other components which are customarily used in the preparation of such polymer wood composite materials, and which would be known to those of skill in the art.

For example, different types of waxes are commonly employed in polymer wood composites in order to enhance the resistance of the composite material to the absorption of moisture and to metal release, while also lowering the viscosity during extrusion processing. Due to the high level of wood flour in the composite material, the appropriate level of waxes are needed in order to prevent the burning of the composite material and to promote the fusion of the composite material. For example, a stearate ester wax (such as glycerol monostearate (GMS)) may be added as an internal lubricant, cell stabilizer and antistatic agent. As an internal chemical antistatic agent, the GMS compound migrates to the substrate surface, improving surface appearance and inner cell structure and via hydrogen bonding with atmospheric water, creating a microscopic layer of water on the substrate surface. As a chemical antistatic agent, it is therefore dependent upon atmospheric moisture for its mechanism to dissipate static electricity. The GMS compound will also help to retain the cell stability while foaming. When present, a stearate ester wax (such as GMS) is preferably present in the composite material in an amount in the range of about 0.0 to 4.0 phr, and more preferably about 0.5 to 3.0 phr.

In addition, at least one low-molecular-weight polyethylene wax can be added as an external lubricant to help provide a high-gloss, water-repellant surface finish, and to facilitate extrusion by helping to prevent the extrudable mixture from adhering to the hot metal surfaces of the processing machinery during extrusion. When present, each low-molecular-weight polyethylene wax is preferably present in the composite material in an amount in the range of about 0.1 to 3.0 phr, and more preferably about 0.2 to 2.0 phr.

Furthermore, several types of processing aids are commonly employed in the production of polymer wood composites. Such processing aids, for example, can provide faster fusion at lower temperatures, reduce residence times and result in improved thermal stability, and provide faster and more complete conveyance along the screw (during extrusion) resulting in a greater output rate. Processing aids can also provide for a better dispersion of foaming agent and a more homogenous melt to the die during extrusion. The addition of processing aids can also reduce plate out, resulting in reduced down time for cleanup and more efficient production. A processing aid may also work as a shear transfer agent, such that when heated under shearing stress, a processing aid first fuses and then sticks to the surrounding polymer (e.g., PVC) particles (due to good compatibility) and conveys the shear stress to them. Exemplary processing aids for use in the present invention include those having differing levels of molecular weight, which correspond to differing levels of efficiency. That is, higher molecular weight processing aids will produce a better efficiency, and promote fusion and melt strength; however, the higher melt strength may possibly result in more shrinkage. Consequently, the use of a combination of processing aids with differing levels of molecular weights is preferred. For example, such a combination may include commercial grade very high molecular weight and medium molecular weight processing aids in order to retain sufficient melt strength while also adjusting the die swell to existing die and calibrator assortments. Furthermore, the addition of low molecular weight processing aids will help to improve the surface aspect of the composite material. When present, each high molecular weight processing aid is preferably present in the composite material in an amount in the range of about 0.5 to 10.0 phr, and more preferably about 3.0 to 8.0 phr; and each low molecular weight processing aid is preferably present in the composite material in an amount in the range of about 0.0 to 4.0 phr, and more preferably about 0.5 to 3.0 phr.

In addition, different types of fillers are commonly employed in polymer wood composites for purposes of material cost savings. For example, calcium carbonate (CaCO₃) is the most common filler used in PVC compounding. The addition of CaCO₃ serves to enhance the composite's modulus of stiffness, while also functioning as a nucleating agent to provide a surface for heterogeneous bubble growth in the foamed composite. Typically, the mineral-calcite grades (also called ground limestone, or simply calcium carbonate) are selected to be CaCO₃ fillers. When present, fillers are preferably present in the composite material in a total amount (of all fillers) in the range of about 0 to 20 phr, and more preferably about 5 to 15 phr.

Other components which may be included in the composite materials include, but are not limited to: an impact modifier, which imparts superior impact properties to rigid vinyl polymeric components (preferably present in an amount in the range of about 0.0 to 4.0 phr, and more preferably about 0.5 to 3.0 phr); and a lubricant, such as calcium stearate, which also functions as a secondary stabilizer as it is an HCl scavenger (preferably present in an amount in the range of about 0.5 to 4.0 phr, and more preferably about 0.5 to 3.0 phr).

In one embodiment of the invention, a lubricant-stabilizer can be added to the composite material, wherein the lubricant-stabilizer comprises at least one processing aid, an impact modifier, at least one wax, a lubricant, a pigment and a foaming agent. The combination of these components to form the lubricant-stabilizer provides for an efficient and convenient means to introduce these components into the composite material, particularly the pigment and the foaming agent. An exemplary embodiment of the composite material including the addition of a lubricant-stabilizer is described in the following example.

### EXAMPLES

Specific preferred embodiments of the invention will now be described with reference to the following examples, which should be regarded in an illustrative rather than a restrictive sense. That is, the composite material and method of the present invention should not be limited to the following exemplary embodiments.

First, an extrudable mixture was formed by mixing together the following components listed below in Table 1 (wherein all known equivalent commercial grades of the items listed below may be used in accordance with the invention):

TABLE 1

| | | | | Preferred Range of | |
|---|---|---|---|---|---|
| | | | | Usage Level, phr (in | |
| | | | Usage Level, | reference to polymeric | Batch Size, |
| Items | Product Code | General Term | phr | (PVC) resin) | lb |
| 1 | F 614 | PVC Resin | 100 | 100 | 156.26 |
| 2 | XAB 5 | Tin Stabilizer | 1.8 | 0.5-3.0 | 2.81 |
| 3 | DINP | Plasticizer | 3 | 1.0-4.0 | 4.69 |
| 4 | S330 | Coupling Agent | 1 | 0.5-3.0 | 1.56 |
| 5 | 232A | Foaming Agent | 2.5 | 0.8-2.5 | 3.91 |
| 6 | P551 | Processing Aid (high | 6 | 3-8.0 | 9.38 |
| | | molecular weight) | | | |
| 7 | P530 | Processing Aid (high | 7 | 3-8.0 | 10.94 |
| | | molecular weight) | | | |
| 8 | K175 | Processing Aid (low | 2 | 0.5-3.0 | 3.13 |
| | | molecular weight) | | | |
| 9 | D200 | Impact Modifier | 1 | 0.5-3.0 | 1.56 |
| 10 | G12/Crill 2NF | Stearate Ester Wax | 1.6 | 0.5-3.0 | 2.50 |
| 11 | 15 F | Calcium Stearate | 2 | 0.5-3.0 | 3.13 |
| 12 | AC629A | Low Molecular Weight | 0.8 | 0.2-2.0 | 1.25 |
| | | (LMW) Polyethylene Wax | | | |
| 13 | WAX-A | Low Molecular Weight | 0.6 | 0.2-2.0 | 0.94 |
| | | (LMW) Polyethylene Wax | | | |
| 14 | 1T | Calcium Carbonate | 8 | 5.0-15.0 | 12.50 |
| 15 | HITOX ® (TiO₂) | Pigment | 2 | 0.5-3.0 | 3.13 |
| 16 | 14030 | Wood Flour | 32 | 15.0-44.0 | 50.00 |

These batch sizes listed above in Table 1 could be changed proportionately based upon the size of the mixing equipment.

Specifically, the extrudable mixture was prepared according to the following mixing protocol, with the following approximate times, temperatures and weight measurements. First, the 156.25 lb of the PVC resin (which constitutes about 58% by weight of the composite material) was added to a high intensity mixer bowl. Then, 1.56 lb of coupling agent S330 is added and mixed for about ten (10) to fifteen (15) seconds, 2.81 lb of the tin stabilizer XAB-5 is then added, and the components are then mixed for about one (1) minute. Next, 50 lb of Oak wood flour (140 mesh) is added, and the mixture is heated up to a temperature in the range of about 210 to 220° F. (preferably about 215° F.). Then, 39.87 lb of the lubricant-stabilizer (as described below in Table 2) is added, and the mixture is heated up to a temperature in the range of about 210 to 220° F. (preferably about 215° F.). Next, 4.69 lb of DINP is added, and the mixture is then heated up to a temperature in the range of about 215 to 225° F. (preferably about 220° F.). Then, 12.50 lb of CaCO₃ is added, and the mixture is heated up to a temperature in the range of about 255 to 265° F. (preferably about 260° F.). Finally, the final mixture (the extrudable mixture) is dumped from the high intensity mixer bowl (hot) to a cold mixer, where it cools down to about 104° F. or less.

TABLE 2
Lubricant-Stabilizer (with ingredients and weight
as originally listed above in Table 1)

| Ingredients | Pounds (lb) |
|---|---|
| P551A (Auto Feno) processing aid | 9.38 |
| P530A (Auto Feno) processing aid | 10.94 |
| K175P (Rohm and Haas) processing aid | 3.13 |
| G 12/Crill 2NF (Croda) stearate ester wax | 2.50 |
| D200, acrylic impact modifier | 1.56 |
| AC629A LMW polyethylene wax oxidized (Honeywell) | 1.25 |
| WAX-A LMW polyethylene wax (BASF) | 0.94 |
| 15F Calcium Stearate | 3.13 |
| HITOX ® (TiO₂) pigment | 3.13 |
| 232A foaming agent | 3.91 |
| TOTAL (lubricants stabilizer) | 39.87 lb |

In the process described above, the high intensity mixer can be constantly mixing such that discharging the high intensity mixer (hot) can stop the mixing batch by batch.

The mixing times listed herein are approximate time values, and these time values should be understood as minimal times, such that they could be extended (for example, extending one minute to more than one minute) while still being in accordance with the present invention. Likewise, the temperatures and weight measurements listed herein are approximate values, and it should be understood that slight deviations or variations therefrom are still in accordance with the present invention.

The extrudable mixture was then linearly extruded through a profile die to form the composite material, according to the extruder operating conditions and procedures listed below, including Table 3. The wood composite extruder used was manufactured by Taiwan Continent Machinery Industries Co., Ltd., and is a CM-PTE95 extruder with a 95 mm screw diameter and a screw L/D of 24. The extruder has five (5) heating zones on the barrel, one (1) heating zone on the adapter and four (4) heating zones on the die. A computer controls the extruder's barrel temperature, screw speed, feeder speed, puller switch, air blower, screw oil, venting vacuum and pumps. The PVC skins co-extruder, manufactured by Taiwan Continent Machinery Industries Co., Ltd., is a CM-PX55 co-extruder used to apply the PVC skins cap stock. The co-extruder has four (4) heating zones on the barrel and one (1) heating zone on the adapter.

TABLE 3
Standard Condition 4 9/16″ Door Jamb Non-Cap Stock
Wood Composite Extruder

Barrel Zone 1: 140° C.
Barrel Zone 2: 140° C.
Barrel Zone 3: 140° C.
Barrel Zone 4: 155° C.
Barrel Zone 5: 155° C.
Adapter Zone: 165° C.
Die Zone 1: 180° C.
Die Zone 2: 180° C.
Die Zone 3: 180° C.
Die Zone 4: 180° C.
Extruder Screw Speed: 242
Feeder Speed: 561
Extruder Vacuum (Hg): 13″
Melt Temperature: 164° C.
Extruder Amps: 67-71
Puller Speed: 24.7 inches per minute
Cooling Water: 51-54° F.
Foot per hour: 123.17
Weight: 8.85 lb @ 85″ long
Pieces per hour: 17.39
Production rate: 153.90 lb/hr
Density: 0.63 gram/cm³ (preferred range is 0.50 to 1.20
g/cm³, most preferred range is 0.60 to 0.90 g/cm³)
Moisture Content: 0.8%-2.0%

In the extrusion processing of the invention, the venting vacuum is located between barrel zone 3 and 4 such that most of the volatiles can be removed from the composite material by emitting from thermal decomposition of the PVC before it passes the blowing zones 4 and 5. During the above-described mixing and heating procedure of the extrudable mixture, most of the moisture can be removed from the components therein, especially from the wood flour. Consequently, the preferred moisture content of the extrudable mixture is in the range of only about 0.8% to 2.0% (most preferably, in the range of about 1.2% to 2.0%) prior to beginning the extrusion process.

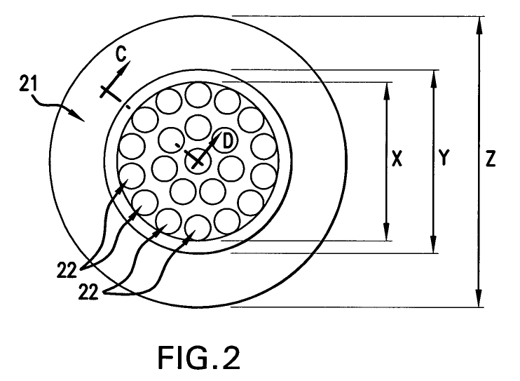

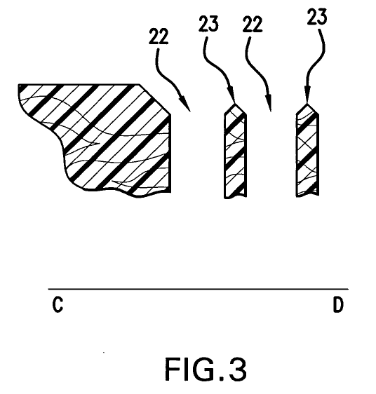

In addition, a breaker plate employing ⅜-inch holes is preferably used in the extrusion process in order to have a higher melt pressure. FIG. 2 shows a schematic representation of an exemplary embodiment of such a breaker plate, and FIG. 3 shows a partial cross-sectional view of the breaker plate shown in FIG. 2 along line C-D as depicted in FIG. 2. In the extrusion process, a breaker plate is often used to artificially generate shear heat to encourage foaming and increase the melt strength at low screw speeds.

In the extrusion processing of the present invention, the breaker plate 21 has about 22 of ⅜-inch (in diameter) tapered holes 22 (with tapered portions 23) in order to improve the melt strength, melt pressure and melt temperature. In the exemplary embodiment of the breaker plate as shown in FIG. 2, the measurements of the lengths X, Y and Z as depicted therein are 2.360 inches, 2.750 inches, and 4.330 inches, respectively. Such a breaker plate serves to minimize the voids in the composite material, and thus produce a composite material having a relatively smaller and more uniform cell structure, thereby reducing its density and assisting in cost savings.

Furthermore, in the extrusion processing in accordance with the invention, a die extension, measuring approximately three (3) to six (6) inches in length, is preferably used which creates a unique combination of a Celuka and a free foam form of tooling. That is, by utilizing the Celuka process for the interior design of the die, the foam is contained by a series of bars or torpedoes such that the extrusion mass is well distributed to all corners, and the development of the cell structure takes place in the first four sections of the die. As the extrusion mass passes over the end of the bar or torpedo, the increased area in the die results in a drop in pressure, thereby allowing expansion of the foam and development of the cell structure. It is at this point in conventional Celuka tooling that the extrusion mass enters the calibrator and begins cooling, wherein the cooling process rapidly advances the polymer recrystallization and freezes the growth of the cells near the surface, forming a dense outer layer that is oftentimes brittle. Because cell growth is stopped as the extrusion mass cools, undesirable voids can be formed due to, for example, too much gas, too much moisture, and too rapid a rate of cooling. Thus, the last part of the die (i.e., the die extension) in the profile tooling takes the extrusion mass and compresses it again between 0 and 30% (i.e., 30% is the die swelling ratio) with no bars or torpedoes. Furthermore, without contacting the cooling surface immediately after the die, this allows the composite material to have a more evenly distributed cell structure throughout the cross section of the material, along with a rougher surface appearance. As a result of such extrusion processing, the composite material will have a lower density, and a higher surface energy for better gluing and paint adhesion than can be achieved with materials produced with the conventional Celuka tooling.

Testing Results

The composite material produced in accordance with the processes described above was then tested for various physical properties, including mechanical strength, durability and thermal bow testing. The samples of the composite material, which were tested, were in the form of a doorjamb. Specifically, the samples consisted of 7-foot sections of the doorjamb. The test specifications employed for these tests were as follows: ASTM D1761-88 (Standard Test Methods for Mechanical Fasteners in Wood); ASTM D1037-96 (Test Methods of Evaluating Properties of Wood-Based Fiber and Particle Panel Materials); ASTM D2240 (Durometer Hardness Test); NWWDA TM-8 (Hinge-Loading Resistance Test); and NWWDA TM-7 (Cycle-Slam Test); each of which is incorporated herein by reference.

All test and measurement equipment used for these tests conformed to the applicable test standards and was calibrated traceable to NIST where required. The nail withdrawal, hinge loading, and modulus of rupture tests were conducted using an Instron model 1011 Universal Test System. This is a constant rate of grip separation type tensile test machine with a 1000-lb load cell. The weights of the specimens tested in the water absorption and thickness-swelling test were determined using a standard laboratory triple beam balance while specimen dimensions for swelling calculations were determined with dial calipers. The cycle-slam test setup was essentially similar to what is detailed in section three (3), and figures one (1) and two (2) of NWWDA TM-7, which are incorporated herein by reference. The ball drop consisted of an apparatus constructed to meet the requirements of ASTM D1037. The thermal bow test used deflection gauges and dial calipers to determine the bow of doorjamb material.

The Nail Withdrawal/Screw Withdrawal test was used to determine the load required to pull one nail out of a prepared section of doorjamb. Specifically, the test samples consisted of a 7-foot section of the doorjamb, which was cut into 3-inch long sections for use in the nail withdrawal test. To begin, a 6-penny plain shank nail was driven into the test specimens at right angles to its surface with ½ inch of the shank of the nail left exposed. Next, the specimen was placed under a holding fixture installed on the base of the Instron tensile tester and the shank of the nail was pulled by wedge type grips connected to the movable crosshead of the tensile tester. The crosshead of the tensile tester moved at a constant rate of 0.1 inches per minute (±25%) until the nail began to withdraw from the specimen and the highest load was recorded. A new nail was used for each of the specimens tested. The specimens were evaluated by averaging the maximum loads achieved, and the results can be seen below in Table 4.

TABLE 4
Results from Nail Withdrawal/Screw Withdrawal

| | | | | | | | | | |
|---|---|---|---|---|---|---|---|---|---|
| | | load 1 | | load 2 | | load 3 | | load 4 | |
| | rate | (lbs) | | (lbs) | | (lbs) | | (lbs) | |
| specimen | (in/min) | peak 1 | peak2 | peak 1 | peak2 | peak 1 | peak2 | peak 1 | peak2 |

Nails

| | | | | | | | | | |
|---|---|---|---|---|---|---|---|---|---|
| 14-aN | 0.12 | 64.77@.05″ | 68.87@.05″ | 43.72@.03″ | 45.0@.03″ | 14.02@.04″ | 80.92@.27″ | 10.22@.07″ | 64.05@.11″ |
| 14-bN | 0.12 | 67.82@.02″ | 63.95@.05″ | 35.52@.02″ | 35.87@.02″ | 14.90@.04″ | 70.65@.26″ | 11.80@.05″ | 81.55@.09″ |
| 14-cN | 0.12 | 43.05@.05″ | 42.25@.05″ | 46.17@.06″ | 45.02@.07″ | 14.17@.02″ | 48.07@.23″ | 28.25@.05″ | 73.32@.27″ |
| 14-dN | 0.12 | 62.35@.05″ | 70.12@.05″ | 36.87@.04″ | 34.87@.04″ | 25.52@.05″ | 74.00@.13″ | 71.02@.06″ | 66.40@.06″ |
| 14-eN | 0.12 | 72.77@.03″ | 62.95@.04″ | 43.30@.04″ | 39.50@.04″ | 13.22@.02″ | 57.42@.23″ | 38.95@.23″ | 43.92@.26″ |
| 14-fN | 0.12 | 83.55@.08″ | 82.50@.08″ | 43.07@.04″ | 44.62@.04″ | 20.62@.09″ | 69.95@.32″ | 30.87@.22″ | 68.05@.24″ |

Screws - 5/64″ diameter piolt hole

| | | | | | | | | | |
|---|---|---|---|---|---|---|---|---|---|
| 14-aS | 0.12 | 310.5@.28″ | 308.0@.28″ | 303.2@.22″ | 300.5@.23″ | 218.0@.17″ | 216.2@.17″ | 200.0@.33″ | 198.2@.34″ |
| 14-bS | 0.12 | 265.5@.50″ | 285.0@.52″ | 262.0@.15″ | 260.0@.16″ | 253.2@.21″ | 251.2@.22″ | 243.2@.29″ | 241.2@.30″ |
| 14-cS | 0.12 | 246.5@.09″ | 244.7@.10″ | 271.7@.22″ | 268.7@.23″ | 250.7@.44″ | 248.5@.45″ | 232.2@.25″ | 230.0@.25″ |
| 14-dS | 0.12 | 298.7@.35″ | 296.2@.36″ | 280.7@.31″ | 278.0@.32″ | 227.5@.24″ | 225.7@.24″ | 273.5@.31″ | 270.7@.32″ |
| 14-eS | 0.12 | 308.7@.16″ | 306.0@.16″ | 272.0@.27″ | 269.2@.28″ | 232.7@.19″ | 230.7@.20″ | 265.2@.17″ | 263.2@.17″ |
| 14-fS | 0.12 | 295.0@.12″ | 292.2@.13″ | 248.5@.18″ | 240.7@.33″ | 171.7@.15″ | 230.2@.2″ | 226.7@.48″ | 225.6@.48″ |

load 1 - thick flat of jamb
load 2 - thin flat of jamb
load 3 - cross sectional end of jamb
load 4 - cross sectional end of jamb

The Water Absorption and Thickness Swelling test may be used as a guide to determine the amount of water that will be absorbed by the doorjamb when in contact with standing water and how that absorption will affect the doorjamb's dimensions. Three (3) 4½-inch-long sections of the doorjamb were used for the water absorption and thickness swelling tests. To begin, the specimens were weighed and measured to determine their thickness and volume. The specimens were then submerged under one inch of distilled water for two (2) hours. They were then allowed to drain for ten (10) minutes and any excess water was removed. The specimens were again weighed and measured. They were then submerged for another twenty-two (22) hours and the process of draining, weighing, and measuring was repeated. The amount of water absorbed was determined by subtracting the constant weight after drying in an oven at 103° C. (±2° C.) from the weight after soaking. Thickness changes were determined via a similar procedure, and swelling was reported as a percentage of original thickness. Results for this testing can be seen below in Table 5.

TABLE 5
Results from Water Absorption and Thickness Swelling

| | | | | | | | | | | | |
|---|---|---|---|---|---|---|---|---|---|---|---|
| | weight | nominal | width | length | thickness A | thickness B | volume | point A | point B | point C | point D |
| specimen | (g) | (in) | (in) | (in) | (in) | (in) | (cu. In.) | (in) | (in) | (in) | (in) |

before soaking

| | | | | | | | | | | | |
|---|---|---|---|---|---|---|---|---|---|---|---|
| 14-1 | 226.3 | 4.5 × 6 | 4.547 | 6.053 | 1.226 | 0.734 | 7.729 | 0.756 | 0.613 | 0.612 | 0.757 |
| 14-2 | 225.5 | 4.5 × 6 | 4.548 | 6.09 | 1.226 | 0.733 | | 0.758 | 0.612 | 0.611 | 0.757 |
| 14-3 | 225.8 | 4.5 × 6 | 4.548 | 6.07 | 1.229 | 0.732 | | 0.759 | 0.613 | 0.615 | 0.756 |

| | | | | | | | | |
|---|---|---|---|---|---|---|---|---|
| | weight | nominal | width | length | point A | point B | point C | point D |
| specimen | (g) | (in) | (in) | (in) | (in) | (in) | (in) | (in) |

2 hoars after soaking

| | | | | | | | | |
|---|---|---|---|---|---|---|---|---|
| 14-1 | 229.4 | 4.5 × 6 | 4.548 | 6.055 | 0.755 | 0.612 | 0.612 | 0.755 |
| 14-2 | 227.6 | 4.5 × 6 | 4.545 | 6.093 | 0.757 | 0.613 | 0.61 | 0.755 |
| 14-3 | 229.3 | 4.5 × 6 | 4.546 | 6.072 | 0.755 | 0.612 | 0.612 | 0.757 |

additional 22 hours after soaking

| | | | | | | | | |
|---|---|---|---|---|---|---|---|---|
| 14-1 | 233.7 | 4.5 × 6 | 4.555 | 6.056 | 0.757 | 0.612 | 0.61 | 0.754 |
| 14-2 | 231.7 | 4.5 × 6 | 4.55 | 6.091 | 0.757 | 0.614 | 0.614 | 0.757 |
| 14-3 | 233.5 | 4.5 × 6 | 4.551 | 6.059 | 0.756 | 0.614 | 0.614 | 0.757 |

after oven dried

| | |
|---|---|
| 14-1 | 224.4 |
| 14-2 | 223.1 |
| 14-3 | 224.1 |

The Hinge-Loading Resistance test determines the force required to pull a standard 4½-inch hinge from the test specimen. This test was performed on a 9½-inch-long section of doorjamb that had approximately 3/32 inch of composite material removed from the hinge-mounting surface to simulate a mortise cut for a hinge. To begin, the location of the mounting holes in the hinge are marked on the specimen and four ⅛-inch diameter pilot holes are drilled to accept #12×1¼-inch type AB screw. Next, one leaf of the hinge was attached to the test specimen and the other leaf was attached to a tang that is pulled by the wedge grip on the movable crosshead of the Instron test machine at a rate of 0.10 inches per minute. The testing was stopped when either the screws had completely withdrawn, the specimens split or cracked, or the screws broke. The maximum load achieved during the test was recorded, and the results for this testing can be seen below in Table 6.

In the Cycle-Slam test, the 7-foot doorjamb specimen is mounted in the cycling fixture and the door is adjusted to open and close with minimal force and no rubbing between the doorframe, the doorjamb and the panel edge. A standard commercial door closer and a crossbar were attached and a double acting air cylinder was placed as shown in FIG. 1 of NWWDA TM-7, which is incorporated herein by reference. After an initial visual inspection was performed, the cycling was started. The doorjamb specimen was cycled at a rate of 24 cycles per minute 125,000 times, and visual inspection was performed every 25,000 cycles. After completing 125,000 cycles, the hinge and lock jambs were still operable and able to continue cycling, no failures of doorjamb/hardware connections were observed, and the doorjamb remained structurally intact and visually unchanged.

The Ball Drop test determines the impact resistance of doorjamb boards struck by moving objects. The test specimen for the ball drop test was a 10-inch-long by 4 9/16 inch-wide doorjamb board which was conditioned at 73° F. and 50% relative humidity for a minimum of twenty-four (24) hours prior to testing. In this test, a 2-inch diameter steel ball is dropped onto the test specimen from one (1) inch, making repeated drops from increasing heights in increments of one (1) inch until a visible fracture is produced on the entire surface. The maximum height that the fracture occurred was recorded to be 66 inches.

The Modulus of Rupture test determines the modulus of rupture of the doorjamb sample. The modulus of rupture test samples were twelve (12) 6-inch-long, 2-inch wide, by ⅜-inch-thick samples of the doorjamb. To begin, the test specimen was centered flatwise on the parallel supports. Then, the load was applied at midspan at an approximately uniform rate of motion at 1 inch/minute crosshead speed. The maximum load at which failure occurs was recorded, and the procedure was repeated with six specimens with the PVC skin on the top, and then with six specimens with the PVC skin on the bottom. These test results can be seen below in Table 7.

In the Thermal Bow test, two (2) complete doorjambs were used for the test specimens. After the test setup was complete, the test specimen was heated to an average specimen surface temperature of 140° F. over 210 minutes and maintained at that temperature for one hour. Deflection and temperature measurements were recorded every fifteen (15) minutes. The cooling phase followed when the average specimen surface temperature was dropped to −12° F. over 215 minutes. Deflection and temperature measurements were recorded every five (5) minutes. The results of this testing can be seen below in Tables 8 and 9.

The Durometer Hardness Test was conducted in accordance with ASTM D2240, which is the recognized specification for the Durometer instrument and test procedures. The test measures hardness by measuring the penetration of an indentor into a specimen. Because the indentor may penetrate the specimen as much as 0.10 inches, it follows that a specimen must be of sufficient thickness to ensure an accurate, sensitive test. Thus, the samples to be tested should not be less than about ¼ inch (6 mm) thick, although exceptions may be made for harder materials because the indentor is operated at less than a half stroke. For the testing of the polymer wood composite material of the present invention, a type D durometer (for use with harder materials) was used. In this testing, the composite material exhibited a hardness in the range of 45 to 80 HRC (Hardness Rockwell C scale).

TABLE 6
Results from Hinge-Loading Resistance Test

| | Rate | Load (lbs) | | Failure |
|---|---|---|---|---|
| Specimen | (in/min) | peak 1 | peak 2 | reason |
| 7-H1 | 0.1 | 233.7 @ .33″ | 231.5 @ .35″ | 1 |
| 7-H2 | 0.1 | 207.7 @ .25″ | 205.7 @ .28″ | 1 |
| 7-H3 | 0.1 | 208.0 @ .26″ | 208.0 @ .28″ | 1 |

Failure reason
1 - complete withdrawal of screws
2 - splitting or cracking of the hinge stile
3 - splitting or breakage of the hinge and/or the screws
7/64″ diameter Pilot Hole
4 - #10 × ¾″ wood screw
1 - 4.5″ hinge

TABLE 7
Results from Modulus of Rupture Test

| | Max | Length of | Width of | Thickness | Modulus of |
|---|---|---|---|---|---|
| | Load | Span | Specimen | of Specimen | Rupture |
| | lbs. | inches | inches | inches | psi |
| Sample # | | | | | |
| PVC | | | | | |
| Side Up | | | | | |
| 1 | 132.0 | 4.000 | 2.011 | 0.362 | 3005.4 |
| 2 | 121.0 | 4.000 | 1.991 | 0.364 | 2752.1 |
| 3 | 145.0 | 4.000 | 2.024 | 0.384 | 2915.1 |
| 4 | 134.0 | 4.000 | 2.011 | 0.375 | 2843.0 |
| 5 | 135.5 | 4.000 | 2.018 | 0.382 | 2760.8 |
| 6 | 135.2 | 4.000 | 2.018 | 0.375 | 2858.5 |
| Average | 133.8 | 4.000 | 2.012 | 0.374 | 2855.8 |
| StdDev | 7.712 | 0.000 | 0.011 | 0.009 | 95.7 |
| Sample # | | | | | |
| PVC Side | | | | | |
| Down | | | | | |
| 1 | 111.5 | 4.000 | 2.008 | 0.365 | 2500.8 |
| 2 | 118.5 | 4.000 | 2.010 | 0.375 | 2515.4 |
| 3 | 113.2 | 4.000 | 2.020 | 0.375 | 2391.0 |
| 4 | 116.5 | 4.000 | 2.019 | 0.382 | 2372.5 |
| 5 | 108.7 | 4.000 | 2.015 | 0.375 | 2301.7 |
| 6 | 110.0 | 4.000 | 2.003 | 0.362 | 2514.5 |
| Average | 113.1 | 4.0 | 2.0 | 0.4 | 2432.7 |
| StdDev | 3.801 | 0.000 | 0.007 | 0.007 | 90.2 |

### Tables 8 and 9—Results from Thermal Bow Test

The results of this testing are presented in Tables 11 and 12. A description of the terms used in Tables 11 and 12 follows.

Deflection A: Deflection in direction perpendicular to door face between top and middle hinge.

Deflection B: Deflection in direction perpendicular to door face between middle and bottom hinge.

Temp (Air): Air temperature inside of chamber

Temp (Top): Thermocouple reading placed in between top and middle hinge.

Temp (bottom): Thermocouple reading placed in between middle and bottom hinge.

D1: Measurement of spacing between Door and jamb located just below top hinge.

D2: Measurement of spacing between Door and jamb located between top and middle hinge.

D3: Measurement of spacing between Door and jamb located just below middle hinge.

D4: Measurement of spacing between Door and jamb located between middle and bottom hinge.

D5: Measurement of spacing between Door and jamb located just below bottom hinge.

TABLE 8
Cold Temperature Soak

| Time | Defl. A | Defl. B | Temp | Temp | Temp | | | | | |
|---|---|---|---|---|---|---|---|---|---|---|
| (min) | (in.) | (in.) | (air) (F.) | (top) (F.) | (bott) (F.) | D1 (in.) | D2 (in.) | D3 (in.) | D4(in.) | D5 (in.) |
| 0 | 0 | 0 | 70 | 69.5 | 69.8 | 0.29 | 0.309 | 0.281 | 0.271 | 0.295 |
| 15 | 0.01 | 0.012 | 10.40 | 26.47 | 21.55 | 0.32 | 0.309 | 0.281 | 0.271 | 0.295 |
| 30 | 0.014 | 0.018 | −5.10 | 14.51 | 6.70 | 0.32 | 0.309 | 0.281 | 0.271 | 0.295 |
| 45 | 0.021 | 0.022 | −12.10 | 2.47 | −3.95 | 0.32 | 0.309 | 0.281 | 0.271 | 0.295 |
| 60 | 0.022 | 0.022 | −14.40 | −0.58 | −6.15 | 0.32 | 0.309 | 0.281 | 0.271 | 0.295 |
| 75 | 0.024 | 0.022 | −14.30 | −2.16 | −7.06 | 0.32 | 0.309 | 0.281 | 0.271 | 0.295 |
| 90 | 0.024 | 0.022 | −14.50 | −2.86 | −7.41 | 0.32 | 0.309 | 0.281 | 0.271 | 0.295 |
| 105 | 0.024 | 0.022 | −14.50 | −2.89 | −7.68 | 0.32 | 0.309 | 0.281 | 0.271 | 0.295 |
| 120 | 0.024 | 0.022 | −14.50 | −2.80 | −7.30 | 0.32 | 0.309 | 0.281 | 0.271 | 0.295 |
| 135 | 0.024 | 0.022 | −14.50 | −3.00 | −7.42 | 0.32 | 0.309 | 0.281 | 0.271 | 0.295 |
| 150 | 0.024 | 0.022 | −14.30 | −3.00 | −7.55 | 0.32 | 0.309 | 0.281 | 0.271 | 0.295 |
| 165 | 0.024 | 0.022 | −14.20 | −3.69 | −7.48 | 0.32 | 0.309 | 0.281 | 0.271 | 0.295 |
| 180 | 0.024 | 0.022 | −15.30 | −5.03 | −9.89 | 0.32 | 0.309 | 0.281 | 0.271 | 0.295 |
| 195 | 0.024 | 0.022 | −16.50 | −6.18 | −10.84 | 0.32 | 0.309 | 0.281 | 0.271 | 0.295 |
| 210 | 0.024 | 0.022 | −17.00 | −7.10 | −11.47 | 0.32 | 0.309 | 0.281 | 0.271 | 0.295 |
| 225 | 0.024 | 0.022 | −16.00 | −8.87 | −12.04 | 0.32 | 0.309 | 0.281 | 0.271 | 0.295 |

TABLE 9
Hot Temperature Soak

| Time | Defl. A | Defl. B | Temp | Temp | Temp | | | | | |
|---|---|---|---|---|---|---|---|---|---|---|
| (min) | (in.) | (in.) | (air) (F.) | (top) (F.) | (bott) (F.) | D1 (in.) | D2 (in.) | D3 (in.) | D4(in.) | D5 (in.) |
| 0 | 0 | 0 | 71.9 | 72.1 | 72.4 | 0.32 | 0.30 | 0.28 | 0.30 | 0.34 |
| 15 | −0.014 | −0.014 | 120.10 | 100.28 | 99.90 | 0.32 | 0.30 | 0.28 | 0.30 | 0.34 |
| 30 | −0.015 | −0.018 | 132.08 | 113.39 | 112.91 | 0.32 | 0.30 | 0.28 | 0.30 | 0.34 |
| 45 | −0.016 | −0.018 | 134.19 | 117.72 | 117.38 | 0.32 | 0.30 | 0.28 | 0.30 | 0.34 |
| 60 | −0.017 | −0.019 | 135.13 | 120.19 | 119.74 | 0.32 | 0.30 | 0.28 | 0.30 | 0.34 |
| 75 | −0.017 | −0.019 | 135.60 | 123.50 | 123.49 | 0.32 | 0.30 | 0.28 | 0.30 | 0.34 |
| 90 | −0.017 | −0.019 | 136.70 | 124.10 | 123.49 | 0.32 | 0.30 | 0.28 | 0.30 | 0.34 |
| 105 | −0.017 | −0.019 | 137.10 | 125.21 | 123.49 | 0.32 | 0.30 | 0.28 | 0.30 | 0.34 |
| 120 | −0.017 | −0.019 | 137.13 | 126.17 | 124.49 | 0.32 | 0.30 | 0.28 | 0.30 | 0.34 |
| 135 | −0.017 | −0.019 | 137.25 | 127.38 | 124.97 | 0.32 | 0.30 | 0.28 | 0.30 | 0.34 |
| 150 | −0.017 | −0.019 | 138.90 | 127.38 | 125.50 | 0.32 | 0.30 | 0.28 | 0.30 | 0.34 |
| 165 | −0.017 | −0.019 | 137.58 | 127.80 | 126.10 | 0.32 | 0.30 | 0.28 | 0.30 | 0.34 |
| 180 | −0.017 | −0.019 | 137.20 | 128.90 | 126.50 | 0.32 | 0.30 | 0.28 | 0.30 | 0.34 |
| 195 | −0.017 | −0.019 | 137.40 | 129.40 | 126.40 | 0.32 | 0.30 | 0.28 | 0.30 | 0.34 |
| 210 | −0.017 | −0.019 | 137.53 | 129.63 | 126.92 | 0.32 | 0.30 | 0.28 | 0.30 | 0.34 |

Table 10 below provides a summary of the testing results of the doorjamb formed from the composite material of the invention, listed in comparison to such testing results of a natural wood doorjamb (pine wood in Table 10).

TABLE 10

| Test Standard | Test Results | Remarks |
|---|---|---|
| ASTM D 1761 | 65.72 lb on thick | Wood Doorjamb |
| Nail | section (section | (Pine wood) has 81.93 |
| Withdrawal Test | B in FIG. 1); | lbs on thin section |
| | 41.44 lb on thin | (section A in FIG. 1) |
| | section (section | |
| | A in FIG. 1) | |
| ASTM D 1761 | 287.48 lb on thick | Wood Doorjamb |
| Screw | section (section | (Pine wood) has 289.7 |
| Withdrawal Test | B in FIG. 1); | lbs on thin section |
| | 273.02 lb on thin | (section A in FIG. 1) |
| | section (section | |
| | A in FIG. 1) | |
| NWWDA TM-8 | 216.5 lbs on thin | Wood Doorjamb |
| Hinge Load | section (section | (Pine wood) |
| Resistance | A in FIG. 1) | has 206 lbs on |
| Test | on each hinge | thin section |
| | | (section A in FIG. 1) |
| NWWDA TM-7 | 275,000 cycles | Testing cycle |
| Cycle Slam Test | with no damage | stopped at |
| | | 275,000 times, |
| | | showing no damage. |
| ASTM D 1037 | 4.06% (9.1 grams) | Wood Doorjamb |
| Water | (per ASTM D1037, | (Pine wood) is |
| Absorption Test | this is the | 13.31% |
| | average value | |
| | of 14-1, 14-2 and | |
| | 14-3 specimens | |
| | as shown in | |
| | Table 5) | |
| ASTM D 1037 | −0.03% | Wood Doorjamb |
| Thickness | (per ASTM D1037, | (Pine wood) is |
| Swelling Test | this is the | 3.67% |
| | average value | |
| | of 14-1, 14-2 and | |
| | 14-3 specimens | |
| | as shown in | |
| | Table 5) | |
| ASTM D 1037 | 66 inch is | |
| Falling Ball | maximum height | |
| Impact Test | before breaking | |
| Thermal Bow Test | No serious | Deflection at |
| | deformation | cold (Air, −12° F.) |
| | for both | is about −0.024 inch; |
| | cold and | Deflection at hot |
| | hot cycle | (Air, 140° F.) |
| | | is about 0.022 inch |
| ASTM D 1037 | 106018.6 psi | Wood Doorjamb |
| Stiffness, psi | | (Pine wood) |
| | | has 146827.6 psi. |
| ASTM D-2240 | 45-80 HRC | Wood Doorjamb |
| Durometer | on thick | (Pine wood) is |
| Hardness | section | 40-50 HRC on |
| Test (Type D | (section | thick section |
| tester) | B in FIG. 1) | (section B in FIG. 1) |

In accordance with ASTM D 1037, the Water Absorption test results and the Thickness Swelling test results listed above in Table 10 were calculated as follows. For the Water Absorption test, the amount of water absorbed was determined by subtracting the constant weight after drying in an oven at 103° C. (±2° C.) from the weight after soaking, and calculating the water absorption (in percent weight) therefrom (as shown below in Table 11 for specimens 14-1, 14-2 and 14-3 from Table 5). For the Thickness Swelling test, the amount of swelling was determined by subtracting the original thickness before soaking from the thickness after soaking, and calculating the thickness swelling (as a percentage of original thickness) therefrom (as shown below in Table 12 for points A, B, C and D of specimens 14-1, 14-2 and 14-3 from Table 5).

TABLE 11

| | weight (g) | | | water |
|---|---|---|---|---|
| | (after | weight (g) | weight (g) | absorption |
| | 24 hours | (after | (of water | (in percent |
| specimen | total soaking) | oven dried) | absorbed) | weight) |
| 14-1 | 233.7 | 224.4 | 9.3 | 4.14% |
| 14-2 | 231.7 | 223.1 | 8.6 | 3.85% |
| 14-3 | 233.5 | 224.1 | 9.4 | 4.19% |
| average | | | 9.1 | 4.06% |

TABLE 12

| | Point A | Point B | Point C | Point D | average of |
|---|---|---|---|---|---|
| | thickness | thickness | thickness | thickness | points A, B, |
| | swelling (% of | swelling (% of | swelling (% of | swelling (% of | C, D (% of |
| | original | original | original | original | original |
| specimen | thickness) | thickness) | thickness) | thickness) | thickness) |
| 14-1 | 0.13 | −0.16 | −0.33 | −0.40 | −0.19 |
| 14-2 | −0.13 | 0.33 | 0.49 | 0.00 | 0.17 |
| 14-3 | −0.40 | 0.16 | −0.16 | 0.13 | −0.07 |
| average | | | | | −0.03 |
| | | | | | (contracting) |

As shown in Table 12, the average value of −0.03% thickness swelling is indicative of a contraction rather than a swelling, such that the average thickness swelling would be 0.00%.

Thus, as can be seen from the test results, the doorjamb formed from the composite material displayed physical properties, such as mechanical strength and durability, which were as good as and often better than those displayed for a pure wood (e.g., pine wood) doorjamb.

What is claimed is:

1. A polymer wood composite material comprising: a polymeric component; wood flour; a coupling agent; a thermal stabilizer component; a plasticizer; a foaming agent; and a pigment;
wherein the composite material exhibits less than 1% thickness swelling and less than 5% by weight water absorption when submerged in water for at least 24 hours, wherein thickness swelling is measured as a percentage of original thickness; and
wherein the composite material has a hardness which is greater than or equal to natural pine wood as measured on the Rockwell C Hardness scale.

2. The composite material of claim 1, wherein:
the polymeric component includes a polyvinyl chloride resin selected from the group consisting of a polyvinyl chloride homopolymer having an inherent viscosity in the range of about 0.65 to 0.94, a polyvinyl chloride copolymer having an inherent viscosity in the range of about 0.65 to 0.94, a polyvinyl chloride terpolymer having an inherent viscosity in the range of about 0.65 to 0.94, and a mixture of polyvinyl chloride polymers having an inherent viscosity in the range of about 0.65 to 0.94;
the wood flour includes a member selected from the group consisting of hard wood flour having a size in the range of 40 mesh to 140 mesh, soft wood flour having a size in the range of 40 mesh to 140 mesh, and a combination of hard and soft wood flour having a size in the range of 40 mesh to 140 mesh;
the coupling agent includes an aminosilane, a mercaptosilane or an alkanolamine;
the thermal stabilizer component includes a liquid mercaptide;
the plasticizer includes a phthalate, a terephthalate, a benzoate, a trimellitate, a pentaerythritol, an adipate, an azelate, a glutarate or a sebacate;
the foaming agent includes an exothermic foaming agent, an endothermic foaming agent, or a mixture of an exothermic foaming agent and an endothermic foaming agent; and
the pigment includes titanium dioxide in a natural color.

3. The composite material of claim 2, wherein:
the polyvinyl chloride resin is present in an amount in the range of about 51 to 70 weight percent of the composite material;
the wood flour is present in an amount in the range of about 26 to 35 phr;
the coupling agent includes an aminosilane which is present in an amount in the range of about 0.5 to 3.0 phr;
the liquid mercaptide is present in an amount in the range of about 0.5 to 3.0 phr;
the plasticizer includes diisononyl phthalate which is present in an amount in the range of about 1.0 to 4.0 phr;
the foaming agent includes an azodicarbonamide which is present in an amount in the range of about 0.8 to 2.5 phr; and
the titanium dioxide in a natural color is present in an amount in the range of about 0.5 to 3.0 phr.

4. The composite material of claim 3, wherein:
the polyvinyl chloride resin is present in an amount of about 58% by weight of the composite material;
the wood flour includes Maple hard wood flour having a size of 80 mesh, which is present in an amount of about 32 phr;
the aminosilane is present in an amount of about 1.0 phr;
the liquid mercaptide is present in an amount of about 1.8 phr;
the diisononyl phthalate is present in an amount of about 3.0 phr;
the azodicarbonamide is present in an amount of about 2.5 phr; and
the titanium dioxide in a natural color is present in an amount of about 2.0 phr.

5. A building component comprising the composite material of claim 1.

6. The building component of claim 5, wherein the building component is selected from the group consisting of a doorjamb, a doorsill, a brick mold, a door stile, and a door rail.

7. The building component of claim 6, wherein the building component is a doorjamb.

8. A building component comprising the composite material of claim 2.

9. The building component of claim 8, wherein the building component is selected from the group consisting of a doorjamb, a doorsill, a brick mold, a door stile and a door rail.

10. The building component of claim 9, wherein the building component is a doorjamb.

11. A building component comprising the composite material of claim 3.

12. The building component of claim 11, wherein the building component is selected from the group consisting of a doorjamb, a doorsill, a brick mold, a door stile and a door rail.

13. The building component of claim 12, wherein the building component is a doorjamb.

14. A building component comprising the composite material of claim 4.

15. The building component of claim 14, wherein the building component is selected from the group consisting of a doorjamb, a doorsill, a brick mold, a door stile and a door rail.

16. The building component of claim 15, wherein the building component is a doorjamb.

17. A method of producing an extrudable mixture for an extrusion process in producing a polymer wood composite material, the method comprising:
adding a polymeric component and a coupling agent to a high intensity mixer bowl;
mixing the polymeric component and the coupling agent for at least about ten seconds to form a first mixture;
adding a thermal stabilizer component to the first mixture to form a second mixture;
mixing the second mixture for at least about one minute;
adding wood flour to the mixed second mixture to form a third mixture;
heating the third mixture to a temperature in the range of about 210 to 220° F.;
adding a lubricant-stabilizer to the heated third mixture to form a fourth mixture;
heating the fourth mixture to a temperature in the range of about 210 to 220° F.;
adding a plasticizer to the heated fourth mixture to form a fifth mixture;
heating the fifth mixture to a temperature in the range of about 215 to 225° F.;
adding a filler to the heated fifth mixture to form a sixth mixture;
heating the sixth mixture to a temperature in the range of about 255 to 265° F.;
removing the heated sixth mixture from the high intensity mixer bowl, and decreasing its temperature to about 104° F. or less, thereby forming the extrudable mixture.

18. The method of claim 17, wherein the lubricant-stabilizer comprises at least one processing aid, an impact modifier, at least one wax, a lubricant, a pigment and a foaming agent.

19. The method of claim 18, wherein:
the polymeric component includes a polyvinyl chloride resin selected from the group consisting of a polyvinyl chloride homopolymer having an inherent viscosity in the range of about 0.65 to 0.94, a polyvinyl chloride copolymer having an inherent viscosity in the range of about 0.65 to 0.94, and a polyvinyl chloride terpolymer having an inherent viscosity in the range of about 0.65 to 0.94;
the coupling agent includes an aminosilane, a mercaptosilane or an alkanolamine;
the thermal stabilizer component includes a liquid mercaptide;
the wood flour includes a member selected from the group consisting of hard wood flour having a size in the range of 40 mesh to 140 mesh, soft wood flour having a size in the range of 40 mesh to 140 mesh, and a combination of hard and soft wood flour having a size in the range of 40 mesh to 140 mesh;
the at least one wax includes a stearate ester wax and at least one polyethylene wax;
the lubricant includes calcium stearate;
the pigment includes titanium dioxide in a natural color;
the foaming agent includes an exothermic foaming agent, an endothermic foaming agent, or a mixture of an exothermic foaming agent and an endothermic foaming agent;
the plasticizer includes a phthalate, a terephthalate, a benzoate, a trimellitate, a pentaerythritol, an adipate, an azelate, a glutarate or a sebacate; and
the filler includes CaCO₃.

20. The method of claim 19, wherein:
the polyvinyl chloride resin is present in an amount in the range of about 51 to 70 weight percent of the polymer wood composite material;
the coupling agent includes an aminosilane which is present in an amount in the range of about 0.5 to 3.0 phr;
the liquid mercaptide is present in an amount in the range of about 0.5 to 3.0 phr;
the wood flour includes a Maple hard wood flour having a size of 80 mesh which is present in an amount in the range of about 26 to 35 phr;
the stearate ester wax is present in an amount in the range of about 0.5 to 3.0 phr;
the at least one polyethylene wax is present in an amount in the range of about 0.2 to 2.0 phr;
the calcium stearate is present in an amount in the range of about 0.5 to 3.0 phr;
the titanium dioxide in a natural color is present in an amount in the range of about 0.5 to 3.0 phr;
the foaming agent includes an azodicarbonamide which is present in an amount in the range of about 0.8 to 2.5 phr;
the plasticizer includes diisononyl phthalate which is present in an amount in the range of about 1.0 to 4.0 phr; and
the CaCO₃ is present in an amount in the range of about 5 to 15 phr.

21. The method of claim 20, wherein:
the polyvinyl chloride resin is present in an amount of about 156.26 pounds;
the aminosilane is present in an amount of about 1.56 pounds;
the liquid mercaptide is present in an amount of about 2.81 pounds;
the Maple hard wood flour having a size of 80 mesh is present in an amount of about 50.0 pounds;
the stearate ester wax is present in an amount of about 2.50 pounds;
the at least one polyethylene wax is present in an amount of about 2.19 pounds;
the calcium stearate is present in an amount of about 3.13 pounds;
the titanium dioxide in a natural color is present in an amount of about 3.13 pounds;
the azodicarbonamide is present in an amount of about 3.91 pounds;
the diisononyl phthalate is present in an amount of about 4.69 pounds; and
the CaCO₃ is present in an amount of about 12.50 pounds.
